(19) United States
(12) Patent Application Publication
(10) Pub. No.: US 2020/0104330 A1
(43) Pub. Date: Apr. 2, 2020

(54) SYSTEM AND METHOD FOR DETERMINING COMPATIBLE INDIVIDUALS FOR A USER

(71) Applicant: LOMI ARTIFICIAL INTELLIGENCE LIMITED, London (GB)

(72) Inventors: Nikolas Kairinos, Limassol (CY); Salvatore Minetti, Thames Ditton (GB)

(21) Appl. No.: 16/578,575

(22) Filed: Sep. 23, 2019

Related U.S. Application Data
(60) Provisional application No. 62/738,350, filed on Sep. 28, 2018.

(51) Int. Cl. G06F 16/9535; H04L 29/06; G06N 5/04; G06F 16/906; G06N 20/00

(52) U.S. Cl. CPC G06F 16/9535; H04L 63/0414; G06N 20/00; G06F 16/906; G06N 5/04

(57) ABSTRACT

Disclosed is system and method for implementing one or more comparisons between data sets that are representative of a plurality of contacts. The method comprises acquisition of user information from at least one source, analysis of the acquired user information that comprises one or more attributes of the user, selecting one or more contacts from a contacts database based on one or more randomised factors, compiling a list of the one or more selected contacts and outputting the list of the one or more selected contacts relating to the user.

### TECHNICAL FIELD

The present disclosure relates generally to match-making methods using artificial intelligence methods, and more specifically, to an adaptive match-making method where a system identifies individuals that are potentially compatible by performing a comparison between individuals and their defining characteristics.

### BACKGROUND

Match-making, whether it is in the context of business or personal life, is an age-old activity that has been carried out with relative degrees of success by humans, to find compatible individuals. Whilst it may be easy for a human entity to associate compatible individuals together, it becomes increasingly more difficult to decipher the set of processes and activities that need to be carried out by a human brain, in order to implement a similar set of processes to be carried out by a machine, such as a computer. Even when that task is carried out, the set of computer-readable instructions may need to be updated to include new logic, and new commands in order to implement the match-making process.

In recent years, the field of machine learning has had great success in the implementation of complex, non-linear processes, that are usually associated with tasks carried out by the human brain. Machine learning methods comprise of algorithms, mathematical and statistical processes that when combined with big datasets, permit the implementation of decision-making activities by a machine such as a computer system. However, and as already mentioned, the success of such system depends on the availability of big datasets. However, it is often the case that only limited amount of data is available, and it becomes difficult to employ such algorithms whose success in carrying out the task at hand relies on the power of big datasets. The lack of a great amount of data to train the algorithm and to carry out the task at hand in a successful manner is referred to as cold-starting.

An existing match-making system implements a collaborative filtering algorithm, where recommendations for one individual are based on the activity of a plurality of second users. For example, an individual may rate items that he likes, then the system may find other users with similar interests and suggests the items that the second users have not seen but were liked by the first user. However, to do so, the corresponding system may require a substantial amount of data to build user profiles and recommendations.

Further, there exist systems, where recommendations are required by or one user to create a social or business link to another user, but there is no historical data present. In the absence of data, the algorithms may rely on data provided initially by the users themselves to create suitable recommendations. However, one major drawback of such system is that many machine-learning systems may fixate on a subset of recommendations. This usually occurs because of positive (negative) re-enforcement, when a first user has identified suitable (unsuitable) suggestions and this allows the system to optimise for further suggestions. The problem is that other suitable recommendations may go un-noticed because the system keeps optimising based on the positive (negative) interaction with the first user. As such, suitable and precious recommendations may be missed.

Furthermore, existing methods of generating compatible individuals for business purposes, for example, sales lead generation, are generated either manually through lead generation websites, call centres, emails or through other outreach activities. From a computational perspective, existing machine learning methods for sales lead generation are interfaced with the user's customer relationship management (CRM) software, email records, and social media accounts in a way that a great amount of data can be used to generate sales leads. However, these approaches can be fragmented, time consuming, and potentially costly. Another problem is technological uncertainty that whether the machine could be built to avoid catastrophic learning. For example, if the machine learned that the client was particularly fond of a singular sales market but that this market was only relevant for the client for a month, how would the machine would avoid becoming focused on that singular market longer-term.

Therefore, in light of the foregoing discussion, there exists a need for a match-making system that is adaptive, trainable, cost-efficient, accurate, and that can carry out a task that involves complex logic processes such as those carried out by the human brain, and that overcomes the problems of existing solutions.

### SUMMARY

The present disclosure seeks to provide a method for implementing one or more comparisons between data sets that are representative of a plurality of contacts.

The present disclosure provides at least a partial solution to the aforementioned technical problem, or problems, associated with known art, wherein a machine learning method has been developed to successfully carry out the required task, of identifying and suggesting compatible individuals, even when limited data sets are available. As such, the present disclosure describes a method that addresses the issue of cold-starting when identifying compatible individuals. The disclosure presents a solution to the cold-start issue in recommendation engines that also sidesteps the fixation problem, where algorithms keep recommending a subset of recommendations, a result of positive/negative feedback bias from the user, whereas the solution presented by the disclosure is highly abstract and therefore significantly more granular in the recommendations it provides.

In one aspect, an embodiment of the present disclosure provides a system including computing hardware that, when in operation, implements one or more comparisons between data sets that are representative of a plurality of contacts, wherein:

(i) the computing hardware includes a data inputting module that acquires user information pertaining to a user from at least one source:
(ii) the computing hardware includes an analysis module that analyses the acquired user information provided from the data inputting module, wherein the acquired user information comprises one or more attributes of the user;
(iii) the computing hardware includes a selection module that selects one or more contacts amongst from a contacts database, based on at least one of: the one or more user attributes, one or more randomised factors;
(iv) the computing hardware includes a compiling module that compiles a list comprising the one or more selected contacts; and
(v) the computing hardware includes an outputting module that outputs the list of the one or more selected contacts relating to the user, wherein the modules of (i) to (v) are implemented using at least one of: digital hardware, custom-designed circuits, software executable on the computing hardware.

Optionally, the data exchange between the modules is implemented in an at least party encrypted and/or obfuscated form to increase data security of operation of the system.

Optionally, the modules are reconfigurable using one or more machine learning algorithms in response to data being processed through the modules.

Optionally, the inputting module, when in operation, receives a user response and/or user activity from the user; wherein the user response and/or user activity indicates a suitability of the one or more contacts in the outputted list;

the analysis module analyses said user response and/or user activity to produce a user preference; and

the selection module selects the one or more contacts amongst the contacts database, based on the user preference, in addition to the one or more user attributes and/or one or more randomised factors.

More optionally, the user response and/or user activity comprises one or more of: the user follows up with one or more recommended leads, and responses received from similar one or more users.

Optionally, the source comprises at least one of: a Customer Relationship management (CRM) interface of the user, an email account of the user, and a social account of the user.

Optionally, the one or more user attributes comprise one or more of: age, sex, intellectual interests, business activities, business interests, geo-location, business title, and job sector, of the user.

Optionally, the selection module further selects one or more contacts based on the one or more contacts having a rating that is lower than a pre-defined threshold value.

In another aspect, an embodiment of the present disclosure provides a method of using a system including computing hardware that, when in operation, implements one or more comparisons between data sets that are representative of a plurality of contacts, wherein:

(i) using a data inputting module included in the computing hardware to acquires user information pertaining to a user from at least one source:
(ii) using an analysis module included in the computing hardware to analyse the acquired user information provided from the data inputting module, wherein the acquired user information comprises one or more attributes of the user;
(iii) using a selection module included in the computing hardware includes select one or more contacts amongst from a contacts database, based on at least one of: the one or more user attributes, one or more randomised factors;
(iv) using a compiling module included in the computing hardware includes to compile a list comprising the one or more selected contacts; and
(v) using an outputting module included in the computing hardware to output the list of the one or more selected contacts relating to the user, wherein the method further includes arranging for the modules of (i) to (v) to be implemented using at least one of: digital hardware, custom-designed circuits, software executable on the computing hardware.

Optionally, the method includes arranging for data exchange between the modules to be implemented in an at least party encrypted and/or obfuscated form to increase data security of operation of the system.

Optionally, the method includes arranging for the modules to be reconfigurable using one or more machine learning algorithms in response to data being processed through the modules.

Optionally, the method further includes:

using the inputting module, when in operation, to receive a user response and/or user activity from the user; wherein the user response and/or user activity indicates a suitability of the one or more contacts in the outputted list;

using the analysis module, when in operation, to analyse said user response and/or user activity to produce a user preference; and

using the selection module, when in operation, to select the one or more contacts amongst the contacts database, based on the user preference, in addition to the one or more user attributes and/or one or more randomised factors.

More optionally, the user response and/or user activity comprises one or more of: the user follows up with one or more recommended leads, and responses received from similar one or more users.

Optionally, the source comprises at least one of: a Customer Relationship management (CRM) interface of the user, an email account of the user, and a social account of the user.

Optionally, the one or more user attributes comprise one or more of: age, sex, intellectual interests, business activities, business interests, geo-location, business title, and job sector, of the user.

Optionally, the method further includes using the selection module to select one or more contacts based on the one or more contacts having a rating that is lower than a pre-defined threshold value.

In yet another aspect, an embodiment of the present disclosure provides a computer program product comprising a non-transitory computer-readable storage medium having computer-readable instructions stored thereon, the computer-readable instructions being executable by a computerized device comprising processing hardware to execute a method of using a system including computing hardware that, when in operation, implements one or more comparisons between data sets that are representative of a plurality of contacts.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of an environment, wherein various embodiments of the present invention can be practiced, in accordance with an embodiment of the present disclosure;

FIG. 2 is an illustration of an AI engine of FIG. 1, in accordance with an embodiment of the present disclosure; and

FIG. 3 is an illustration of a method for determining one or more compatible other users for a user, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In overview, embodiments of the present disclosure are concerned with providing an adaptive match-making method, where a system identifies individuals that are potentially compatible by performing a comparison between individuals and their defining characteristics. The defining characteristics of individuals comprise of, but are not limited to, age, sex, intellectual interests, business activities, and business interests. As such, embodiments of the adaptive match-making method comprise of a system that carries out the method, where the system suggests suitable business associates or suitable partners in general to the end-users. Furthermore, the system is dynamically adjusting based on user's responses in order to generate new and closer-matched suggestions.

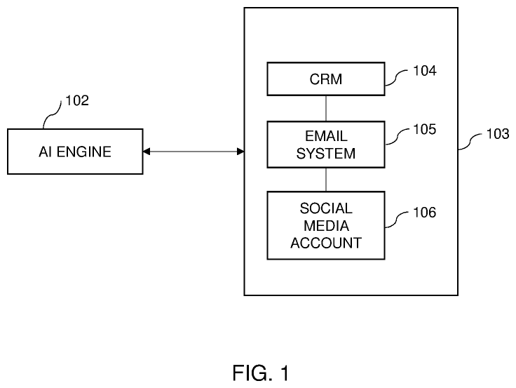

FIG. 1 illustrates an environment 100, wherein various embodiments of the present invention can be practiced.

The environment 100 includes an Artificial Intelligence (AI) engine 102 that is configured to create dynamic neural attribution (DNA) from a cold start position, which means it can intelligently compute attributes which are liked by one entity and match these with the attributes of another, with limited information to start with. The cold starting refers to the process of learning with minimal to no data input into the AI engine 102.

However, once optimized, the AI engine 102 is capable of being used in several contexts and for a variety of applications. Examples of the applications include, but are not limited to:
i. Generating sales-leads for sales people i.e. matching sellers and buyers,
ii. Generating compatible business partners,
iii. Matching prospective employees with employers for human resources and recruitment purposes,
iv. Matching prospective individuals at intelligent dating sites, and
v. Successful and automated machine person-to-person matching

In an embodiment of the present disclosure, the AI engine 102 creates the DNA that it would use to match compatible individuals/entities. Also, the creation of DNA is not determined by a fixed criteria, for example, it's not like that, that a vegetarian individual is being matched with only another vegetarian. The DNA is being built without any pre-set notions, resulting in a greater level of abstraction and granularity in the DNA eventually created.

In an embodiment of the present disclosure, the AI engine 102 is configured to generate leads for sales, for a client 103, with minimal starting data. In such case, the AI engine 102 may be interfaced with Customer Relationship Management (CRM) 104, an email system 105 and a social media account 106 of the client 103, for generating external leads randomly for the client 103. Depending on the interaction with the sales person, reinforcement points would be created. These interactions/reinforcement points would result in adjustments to an initial template DNA to create a DNA which would be specific to the client 103, matching to an increasing extent attributes preferred by the client 103, with attributes of potential sales leads, the client 103 interacted positively with. The elements common across attributes could number in the thousands, which would create a highly granular DNA.

In an embodiment of the present disclosure, randomization has been introduced into the AI engine 102 to ensure it keeps learning and does not become stuck in a loop. Also, the AI engine 102 has implemented wrapper layers to ensure the storage of structured data. Development has also been done for integrating the AI engine 102 into the core system.

In an embodiment of the present disclosure, the AI engine 102 implements a set of algorithms and a unique underlying knowledge representation system, which are not available in the public domain. The AI engine 102 is being trained based on real-data from a limited number of users, who would employ the platform for their day to day work.

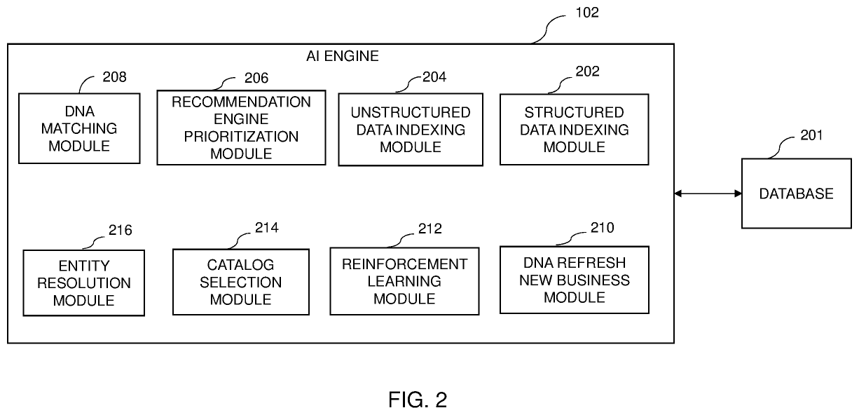

FIG. 2 illustrates the AI engine 102 in detail, in accordance with an embodiment of the present disclosure. The AI engine 102 includes a structured data indexing module 202, an unstructured data indexing module 204, a recommendation engine prioritization module 206, a DNA matching module 208, a DNA refresh new business module 210, a reinforcement learning module 212, a catalog selection module 214, and an entity resolution module 216. The AI engine 102 is designed to be capable of functioning from a cold start position.

The structured data indexing module 202 is configured to categorize and index new data from a data source as soon as the new data source is connected. The data is structured as it exists in a form that can be easily obtained, indexed and manipulated. The structured data would include all the properties outlined in the spec document, including the source, and time/date. In an embodiment of the present invention, the structured data indexing module 202 is configured to assign an initial score value defined as Attribute Confidence (ACO) to a newly indexed item, and then perform a re-indexing step periodically to keep the database updated. In an example, depending on the amount of data retrieved from the data source, it may be fully re-indexed once a week or once every two weeks.

The ACO is an indication of how confident the system is in the accuracy of the attribute (by edge, of which there can be multiple per attribute). Initial value of each edge: If labelled data, 1.0, else 0.5. Possible range: 0 to 1.0. Actual attribute confidence value is calculated as average of DNA to attribute edges, which implies a possible range of 0 to 1.0. The gravity factor reduces each confidence over time, and is a function of how long the attribute has been in the system.

In a further example, an initial value of ACO is 1. The ACO degrades over time unless the indexed item is encountered again or interacted with. The average ACO for each attribute connected to a user or company is calculated by this algorithm as a final step after all the data sources are indexed or refreshed (not each time one is updated), so that the averages can be calculated once per session, not each time an edge ACO is updated.

The unstructured data indexing module 204 is configured to convert unstructured/unlabeled bodies of text into a series of keywords (including phrases up to 3 words long). The new data is unstructured when it is not from a database or from a spreadsheet. In the various filtering steps, the unstructured data indexing module 204 removes high and low frequency words, and also filters out non-English and other inappropriate keywords, based on publicly available resources, and also passes remaining words through a black-list filter. The remaining words may be further abstracted into one or more categories. For example, the words Muslim or Christian etc may be labelled as religion. The unstructured data indexing module 204 does not add entities, but unlabeled attributes to existing entities (person or company).

In an embodiment of the present disclosure, the incoming data may be checked against a blacklist. If present on the blacklist, the data may not be added to the GP. The incoming data may also be checked against a sanitization list. If present on the sanitization list, the data may be converted to a category.

In addition to the above, the unstructured data indexing module 204 is configured to perform all the functions of the structured data indexing module 202.

The recommendation engine prioritization module 206 is configured to assign users to a profile that has fewer recommendations than a given threshold. The corresponding algorithm runs on a daily basis, and is used to determine which DNA's require additional attributes to generate more search results.

The DNA matching module 208 is configured to perform a search in an existing database using a user's business-related attributes such as geolocation, business titles, job sector etc and the user's non-business activities (eg chess, golf etc) to match the user with other similar users, if a user profile has been deemed as “inactive” under suitable thresholds. If similar results have been previously presented and the user has interacted with them, or if the results have been previously presented to colleagues within the same business, then these are removed from the search. If the results returned are less than a threshold, the user profile is flagged as the one which needs more features/attributes.

In an embodiment of the present disclosure, the DNA matching module 208 is configured to perform a series of searches and filters against the data to yield sufficient quality leads for each user. The corresponding algorithm runs on a daily basis and continue running till a predefined period.

In an example, the DNA matching module 208 is intended to generate sufficient leads to ensure that there are enough for at least 5 days. The leads may be stored in a queue and delivered to users at the required daily rate. The corresponding algorithm runs once a day, but only for DNAs that don't have sufficient search results in queue.

In an embodiment of the present disclosure, the DNA matching module 208 is used to determine how similar a possible lead is to a user's DNA (this quantifies how good a match is for the user). This value is used to determine which leads to present to users.

The DNA matching module 208 is configured to update the ACO by adjusting gravity for every attribute it encounters. Since ACO is only used by this algorithm, the value only needs to be updated when it encounters an attributed in a search result. There's no benefit to doing this at any other time, as that would be a waste of computational resource (since we don't use people attributes unless the people show up in a search result). Leads are not only user specific; they are specific to user-business combinations (which means if a user changes her business in the system, the leads generated will change dramatically). Leads previously declined, expired or assigned have a 90-day moratorium, and it has to be ensured that no duplicates are delivered to users in a company-location. It's okay to deliver the same lead to two people in the same company, as long as they are in different locations. Further, leads previously accepted are never shown to the user again for a year (if they not present in the user's accounts—CRM, email, social, etc). To ensure the DNA keeps growing, one should never run out of the leads to be delivered to each user, therefore, those leads are not filtered out, that don't strictly match every attribute in the DNA. (Location is an exception if the user set the target location in his profile). However, some leads may not have a location associated to them, therefore, those leads are allowed, where location is unknown.

In an example, let's say a user's DNA contains the following titles: CIO, CEO, and CTO. Most of the leads delivered will include one of these titles, but we will also show them leads with other titles, such as COO, for instance, as long as there are other matching attributes. If more than the required number of leads is generated, the balance will be kept in reserve, so that the system doesn't need to search for them the next day.

In an embodiment of the present disclosure, the DNA matching module 208 is configured to flag DNAs that don't generate at least 100 search results every time a search is done against the GP. The DNA-catalog-flag set achieves the same objective more elegantly and with less computation.

The DNA refresh new business module 210 is configured to perform re-indexing of a user profile, and associate a user profile with new features, every time, the user changes job description. This corresponding algorithm runs every time a user changes his/her business via their profile. It also runs every time, a user changes his/her selection of ideal clients. The reason for this is that this needs to refresh the DNA, as leads are specific to business and ideal clients. The corresponding algorithm changes the source value of attributes set to “onboarding” to “unstructured” and removes any labels, if they are no longer present in the updated profile (including business and ideal clients). In this case, the ACO for the attribute is reduced by 0.5. If the selection of a new business requires a valid invite code from a manager, the user's leads are locked until a valid invite code is entered.

The refreshment learning module 212 is configured to adjust a user's features/associations based on their activity (changes ACO score mentioned above). For features/profiles, that the user has not interacted with the feature is updated with a reduced ACO score. If the feature's score is zero, then the feature is removed completely. For those features/users that the user interacted with, then a separate scoring scheme exists as follows:
The user accepting a lead (+2).
The user deleting a lead (−2).
The user assigning a lead (+1).
The user deferring a lead (0).
The user ignoring a lead for more than 72 hours (−1).
The user communicating with the lead via email (+2).
The user connecting with the lead on LinkedIn (+2).
The user disconnects with the lead on LinkedIn (−2)
The user connecting with the lead on Facebook (+2).
The user disconnects with the lead on Facebook (−2).
Positive activity relating to the lead in Salesforce or Dynamics (+2).
Negative activity relating to the lead in Salesforce or Dynamics (−2).
The user adding an appointment with the lead on his calendar (+2).

For those connections under a given threshold, the attributes/features of the first user are re-evaluated that gave rise to the connection using an internal scoring scheme. Once an attribute has reached a zero value, it is removed from the user's defining features.

In an embodiment of the present disclosure, the refreshment learning module 212 is configured to update the weight of each DNA-attribute edge based on user reinforcement, also updates the average of the DNA-attribute edges that are reinforced, and also updates the global attribute weight of each attributed weight reinforced. This is done after all the DNA-attribute edge weights are updated (not each time one is updated), so that the averages can be calculated once per day, not each time an edge weight is updated.

Steps implemented by the refreshment learning module 212:
Trigger to run once per day
If it's been 7 days since last gravity update, loop through all active DNAs Loop through all attributes in the DNA
If the attribute was reinforced in the last 7 days:
Update the average Attribute Weights (AWEs) (DNA to attribute and attribute globally). This is a quantification of the extent to which the containing leads (delivered to clients) have been positively and negatively reinforced. Only present in DNA to attribute edges (not in people to attribute edges).
next attribute (skip the rest of the loop)
If the attribute source==onboarding, then subtract 0.05 from the weight of each DNA-attribute edge (gravity)
Else, subtract 0.075 from the weight of each DNA-attribute edge (gravity)
Update the AWE averages
Remove edges with a weight<=0
Next attribute.

The catalog selection module 214 is configured to determine which attributes should be added/removed to the catalog in the recommendation engine. A global average scheme is used to obtain the most popular attributes present in the system. The most popular attributes remain in the catalog, where popularity is ranked based and rank is based on an internal score system. Each attribute is assigned a score based on the interaction of a user with the recommendation they were given. For example, if a set of attributes of a user led to a positive interaction then they are ranked higher based on an internal scoring system. If not, they are ranked lower based on the internal scoring system.

In an example, the number of catalog items are reduced to 100,000, and the AWE is used to sort attributes in order of descending weight. Simply, the attributes with the top 100,000 AWE values are selected to populate the catalog. Further, the selection of the top 100,000 is done on a weekly basis, and the catalog is updated on the weekly basis. Furthermore, attributes ranking 100,001 and below are deleted from the catalog weekly.

The entity resolution module 216 is configured to use external databases to confirm identities of users, and flag users with confirmed duplicate entries. This includes, business, people and locations.

From a mathematical perspective, this solution can be referred to as the steady-state of a system. The randomisation aspect, keeps the system away from a steady-state. As such, the system never completely settles into a particular state and cannot fixate on a sub-set of recommendations. Hence, the system will keep recommending a plurality of new users to the first user. Where the invention differs from existing systems is that it introduces randomisation into the system, and also generate external leads.

The AI engine 102 thus saves time and effort and allows businesses to focus on other aspects, such as closing business deals after the successful match, instead of having to find compatible business partners. Further, the AI engine 102 allows prospective business patterns to plan out the details of their business, instead of spending time finding suitable partners. Furthermore, the AI engine 102 allows businesses to find the right individuals for the right job instead of spending time at interviews. Furthermore, the AI engine 102 allows individuals to find the right person to spend time with, even when big data sets are not available.

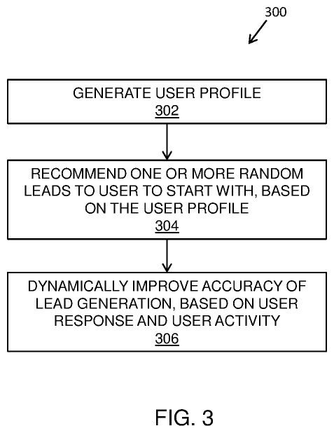

FIG. 3 illustrates steps of a method determining one or more compatible other users for a user, in accordance with an embodiment of the present disclosure. The method is depicted as a collection of steps in a logical flow diagram, which represents a sequence of steps that can be implemented in hardware, software, or a combination thereof.

At a step 302, a user profile is generated from at least one of: a Customer Relationship management (CRM) interface of the user, an email account of the user, and a social account of the user.

At a step 304, one or more random leads are recommended to the user to start with, based on the user profile.

At a step 306, the accuracy of lead generation is dynamically improved based on the user response and user activity.

The steps 302 to 306 are only illustrative and other alternatives can also be provided where one or more steps are added, one or more steps are removed, or one or more steps are provided in a different sequence without departing from the scope of the claims herein.

Optionally, the method includes arranging for data exchange between the modules to be implemented in an at least party encrypted and/or obfuscated form to increase data security of operation of the system.

Optionally, the method includes arranging for the modules to be reconfigurable using one or more machine learning algorithms in response to data being processed through the modules.

Optionally, the method further includes:

using the inputting module, when in operation, to receive a user response and/or user activity from the user; wherein the user response and/or user activity indicates a suitability of the one or more contacts in the outputted list;

using the analysis module, when in operation, to analyse said user response and/or user activity to produce a user preference; and

using the selection module, when in operation, to select the one or more contacts amongst the contacts database, based on the user preference, in addition to the one or more user attributes and/or one or more randomised factors.

Optionally, the user response and/or user activity comprises one or more of: the user follows up with one or more recommended leads, and responses received from similar one or more users.

Optionally, the source comprises at least one of: a Customer Relationship management (CRM) interface of the user, an email account of the user, and a social account of the user.

Optionally, the one or more user attributes comprise one or more of: age, sex, intellectual interests, business activities, business interests, geo-location, business title, and job sector, of the user.

Optionally, the method further includes using the selection module to select one or more contacts based on the one or more contacts having a rating that is lower than a pre-defined threshold value.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system including computing hardware that, when in operation, implements one or more comparisons between data sets that are representative of a plurality of contacts, wherein:
(i) the computing hardware includes a data inputting module that acquires user information pertaining to a user from at least one source;
(ii) the computing hardware includes an analysis module that analyses the acquired user information provided from the data inputting module, wherein the acquired user information comprises one or more attributes of the user;
(iii) the computing hardware includes a selection module that selects one or more contacts amongst from a contacts database, based on at least one of: the one or more user attributes, one or more randomised factors;
(iv) the computing hardware includes a compiling module that compiles a list comprising the one or more selected contacts; and
(v) the computing hardware includes an outputting module that outputs the list of the one or more selected contacts relating to the user,
wherein the modules of (i) to (v) are implemented using at least one of: digital hardware, custom-designed circuits, software executable on the computing hardware.

2. The system of claim 1, wherein data exchange between the modules is implemented in an at least party encrypted and/or obfuscated form to increase data security of operation of the system.

3. The system of claim 1, wherein the modules are reconfigurable using one or more machine learning algorithms in response to data being processed through the modules.

4. The system of claim 1, wherein:
the inputting module, when in operation, receives a user response and/or user activity from the user; wherein the user response and/or user activity indicates a suitability of the one or more contacts in the outputted list;
the analysis module analyses said user response and/or user activity to produce a user preference; and
the selection module selects the one or more contacts amongst the contacts database, based on the user preference, in addition to the one or more user attributes and/or one or more randomised factors.

5. The system of claim 4, wherein the user response and/or user activity comprises one or more of: the user follows up with one or more recommended leads, and responses received from similar one or more users.

6. The system of claim 1, wherein the source comprises at least one of: a Customer Relationship management (CRM) interface of the user, an email account of the user, and a social account of the user.

7. The system of claim 1, wherein the one or more user attributes comprise one or more of: age, sex, intellectual interests, business activities, business interests, geo-location, business title, and job sector, of the user.

8. The system of claim 1, wherein the selection module further selects one or more contacts based on the one or more contacts having a rating that is lower than a pre-defined threshold value.

9. A method (for) of using a system including computing hardware that, when in operation, implements one or more comparisons between data sets that are representative of a plurality of contacts, wherein:
(i) using a data inputting module included in the computing hardware to acquires user information pertaining to a user from at least one source:
(ii) using an analysis module included in the computing hardware to analyse the acquired user information provided from the data inputting module, wherein the acquired user information comprises one or more attributes of the user;
(iii) using a selection module included in the computing hardware includes select one or more contacts amongst from a contacts database, based on at least one of: the one or more user attributes, one or more randomised factors;
(iv) using a compiling module included in the computing hardware includes to compile a list comprising the one or more selected contacts; and
(v) using an outputting module included in the computing hardware to output the list of the one or more selected contacts relating to the user,
wherein the method further includes arranging for the modules of (i) to (v) to be implemented using at least one of: digital hardware, custom-designed circuits, software executable on the computing hardware.

10. The method of claim 9, wherein he method includes arranging for data exchange between the modules to be implemented in an at least party encrypted and/or obfuscated form to increase data security of operation of the system.

11. The method of claim 9, wherein method includes arranging for the modules to be reconfigurable using one or more machine learning algorithms in response to data being processed through the modules.

12. The method of claim 9, wherein the method further includes:
using the inputting module, when in operation, to receive a user response and/or user activity from the user; wherein the user response and/or user activity indicates a suitability of the one or more contacts in the outputted list;
using the analysis module, when in operation, to analyse said user response and/or user activity to produce a user preference; and
using the selection module, when in operation, to select the one or more contacts amongst the contacts database, based on the user preference, in addition to the one or more user attributes and/or one or more randomised factors.

13. The method of claim 12, wherein the user response and/or user activity comprises one or more of: the user follows up with one or more recommended leads, and responses received from similar one or more users.

14. The method of claim 9, wherein the source comprises at least one of: a Customer Relationship management (CRM) interface of the user, an email account of the user, and a social account of the user.

15. The method of claim 9, wherein the one or more user attributes comprise one or more of: age, sex, intellectual interests, business activities, business interests, geo-location, business title, and job sector, of the user.

16. The method of claim 9, wherein the method further includes using the selection module to select one or more contacts based on the one or more contacts having a rating that is lower than a pre-defined threshold value.

17. A computer program product comprising a non-transitory computer-readable storage medium having computer-readable instructions stored thereon, the computer-readable instructions being executable by a computerized device comprising processing hardware to execute a method of claim 9.
